(19) United States
(12) Patent Application Publication
(10) Pub. No.: US 2023/0177806 A1
(43) Pub. Date: Jun. 8, 2023

(54) METHOD, COMPUTER PROGRAM PRODUCT AND APPARATUS FOR VISUAL SEARCHING

(71) Applicant: Google LLC, Mountain View, CA (US)

(72) Inventor: Laura Eidem, Los Altos, CA (US)

(21) Appl. No.: 17/997,812

(22) PCT Filed: May 13, 2020
(86) PCT No.: PCT/US2020/032681

§ 371 Date: Nov. 2, 2022

(51) Int. Cl. G06V 10/72; G06V 10/764; G06V 10/75; G06F 16/532

(52) U.S. Cl. CPC G06V 10/72; G06V 10/764; G06V 10/75; G06F 16/532

(57) ABSTRACT

Techniques of performing a visual search include updating probability distributions based on a succession of frames containing object images until a specified condition has been satisfied and producing a search result for the object only after the specified condition has been satisfied. When a user captures an image of a scene using a device, a front-end, visual search application running on the device obtains successive image frames and sends a first image frame to a back-end computer configured to perform a classification on the frame. The back-end computer obtains a prior probability distribution and generates a likelihood function indicating whether the image frame includes an object. The back-end computer then updates the prior probability distribution by adding respective values of parameters associated with the prior and likelihood function.

### TECHNICAL FIELD

This description relates to performing visual search on objects in images.

### BACKGROUND

Computer vision is a technology used to classify images of objects in a scene. For example, some search engines are configured to produce a search result based on an input image of an object. In such a search engine, a machine learning engine such as a convolutional neural network is trained as a classifier to classify the image as belonging to one of several classes. For example, an image of a four-legged animal may be classified as a dog, cat, horse, sheep, or cow.

### SUMMARY

Implementations provide a backend visual search function that is configured to present stable search results based on objects in image data sent from devices running a visual search application or operation. For example, a mobile device (e.g., a smartphone) may use a sensing device (e.g., a camera) to capture images of scenes that include an object (e.g., a menu at a restaurant). The visual search application causes the device to compress and transmit the image to a client computer (e.g., a digital supplement server). The client computer retrieves a prior (i.e., a Bayesian prior) probability distribution (e.g., a beta distribution) of the objects belonging to an object class (e.g., the class of menus). The client computer then initiates a coarse classification of the image data with a backend server using the image data, and the backend server produces a current distribution of probabilities of the image including an object belonging to the object class. The client computer in response updates the prior probability distribution based on the previous prior distribution and the current distribution. When the prior probability distribution is a beta distribution, then the current distribution may be taken as the conjugate prior, i.e., a binomial distribution with parameters indicating whether the classification resulted in the object belonging to the object class. In this case, updating the prior probability distribution involves adding values of the parameters of the current probability distribution to corresponding values of the parameters of the prior probability distribution. Once updated, the client computer compares a measure of the prior probability distribution (e.g., the mean of the distribution) to a threshold. The client computer only returns a search result for the object when the updated measure of the prior probability distribution is greater than the threshold. In this way, the visual search function is more stable and efficient and improves the user experience.

In one general aspect, a method can include receiving, during a visual search operation for an object in a scene, first image data and second image data from a device, the first image data representing a first image of the scene at a first time and second image data representing a second image of the scene at a second time. The method can also include generating a first visual match probability (i.e., a probability of a match between the object and objects in a coarse object class) based on the first image data, the first visual match probability indicating a likelihood that the object included in the first image of the scene in the first image of the scene belongs to an object class. The method can further include, in response to determining that the first visual match probability not satisfying a criterion, updating the first visual match probability based on the second image data to produce a second visual match probability. The method can further include, after determining that the second visual match probability satisfies the criterion, sending a digital supplement associated with the object to the device as part of the visual search operation.

In another general aspect, a computer program product comprises a non-transitory storage medium, the computer program product including code that, when executed by processing circuitry of a computing device, causes the processing circuitry to perform a method. The method can include receiving, during a visual search operation for an object in a scene, first image data and second image data from a device, the first image data representing a first image of the scene at a first time and second image data representing a second image of the scene at a second time. The method can also include generating a first visual match probability based on the first image data, the first visual match probability indicating a likelihood that the object included in the first image of the scene in the first image of the scene belongs to a coarse object class. The method can further include, in response to determining that the first visual match probability not satisfying a first criterion, updating the first visual match probability based on the second image data to produce a second visual match probability. The method can further include, after determining that the second visual match probability satisfies the first criterion, determining a likelihood that the object belongs to a fine object class. The method can further include, in response to determining that the likelihood of the object belonging to the fine object class satisfies a second criterion, sending a digital supplement associated with the object to the device as part of the visual search operation.

In another general aspect, an electronic apparatus configured to generate a recrawling policy comprises memory and controlling circuitry coupled to the memory. The controlling circuitry can be configured to receive, during a visual search operation for an object in a scene, first image data and second image data from a device, the first image data representing a first image of the scene at a first time and second image data representing a second image of the scene at a second time. The controlling circuitry can also be configured to generate a first visual match probability based on the first image data, the first visual match probability indicating a likelihood that the object included in the first image of the scene in the first image of the scene belongs to an object class. The controlling circuitry can also be configured to, in response to determining that the first visual match probability not satisfying a criterion, update the first visual match probability based on the second image data to produce a second visual match probability. The controlling circuitry can also be configured to, after determining that the second visual match probability satisfies the criterion, send a digital supplement associated with the object to the device as part of the visual search operation.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram that illustrates an example electronic environment in which improved techniques described herein may be implemented.

FIG. 1B is a diagram that illustrates an example scene containing an object and a device configured to capture an image of the object.

FIG. 1C is a diagram that illustrates an example digital supplement retrieved by the device associated with the object in the scene according to disclosed implementations.

FIG. 2 is a flow chart that illustrates an example method of performing a visual search, according to disclosed implementations.

FIG. 3 is a sequence diagram of an example visual search according to disclosed implementations.

FIG. 4 is a flow chart that illustrates an example visual search decision process.

FIG. 5 is a diagram that illustrates a plot of successive prior probability distributions.

FIG. 6 is a diagram of an example evaluation process for a recrawl strategy.

### DETAILED DESCRIPTION

Some classifiers used in a visual search application or operation output, based on the image input, a probability associated with each such classification indicative of a likelihood that the image includes an object that indeed belongs to a particular object class. Some classifiers, however, have more refined classification outputs. For example, given that a classifier associates an image with a dog, that classifier can then determine whether the dog is a hound, and if it is a hound, whether it is a beagle, a basset hound, or a wolfhound. The classifier may further assign probabilities to each of the branches of these subclasses by the classifier, and the probabilities may generally vary with branch. In this case, rather than a single probability value, the classifier may assign a distribution of probabilities to each class.

Conventional classifiers used in a visual search application return a classification corresponding to a most probable class above a detection threshold and update their probability distributions for each of their classes after assigning an image to a class. In this way, if the initial classification of the image is indicated to be incorrect by a user, the classifier can use the new data provided by the indication.

A technical problem in performing visual search is that the above-described conventional classifiers produce classification results with each input image. Each classification operation performed by a classifier uses significant computational resources and may cause the search engine served by the classifier to appear sluggish to the user. Moreover, in many cases a coarse object detection (i.e., a classification based on distributions at a first branch of a search tree) may vacillate when a probability distribution mean is near a threshold. Such a vacillation may also cause apparent instabilities in the search engine behavior, which may further degrade the user experience. Hence, a coarse object class comprises less specific object classes.

In accordance with the implementations described herein, a technical solution to the above-described technical problem includes updating probability distributions based on a succession of frames containing object images until a specified condition has been satisfied and producing a search result for the object only after the specified condition has been satisfied. For example, when a user points a device such as a smartphone camera at a poster containing a map of a country, a front-end, visual search application running on the smartphone obtains successive image frames that include an image of the map, compresses each frame, and sends a first compressed frame to a back-end computer configured to perform a classification on the frame. Based on previous training results, the back-end computer obtains an initial prior probability distribution. Based on the received image frame, the back-end computer generates a current probability distribution indicating whether the image frame includes an object, i.e., a map of the country. The back-end computer then updates the prior probability distribution by computing a posterior probability distribution. In some implementations, when the prior distribution is a beta distribution and the current distribution is a conjugate of the prior, i.e., a binomial distribution, then the updating involves adding respective values of parameters associated with the distributions. In some implementations, the updating involves incrementing the value of one of the parameters of the beta distribution according to whether the frame is classified at a coarse level as including the object or not. The back-end computer then evaluates a probability measure of the updated prior distribution (e.g., the mean of the distribution) and compares the probability measure to a threshold, i.e., the minimum value of the probability measure for which it is likely that the image frame includes the object in the object class. Once the threshold has been exceeded, the back-end computer fetches a digital supplement from a search server and delivers the search result to the smartphone.

In some implementations, the object class is a coarse object class and further refinements of the coarse object class are performed prior to sending the digital supplement to the device. For example, if the object is a map of Martha's Vineyard, a coarse object class can be “maps.” Finer refined classes may include “map of country is United States,” “map of United States includes map of Massachusetts,” and “map of Massachusetts includes Martha's Vineyard.” The back-end computer repeats the derivation of the visual search probability distributions; these distributions are expected to become narrower the more refined the object class becomes. In some implementations, the back-end computer may determine a level of refinement of the object class at which, once the prior probability distribution satisfies a refined criterion, the back-end computer may obtain and send a digital supplement to the device. In some implementations, the determination of satisfaction of coarse and refined criteria are carried out in parallel. In some implementations, there is a further criterion for determined a final level of refinement.

A technical advantage of disclosed implementations is that, by taking in successive frames and updating the probability distributions in real time with each frame, much of the roundtrip communications between a front-end application running on a device and a back-end computer performing a classification on the image are eliminated, thus reducing the time and resources necessary to return a correct search result. Moreover, the search process may be more stable because the updating process on the server is likely to suppress information from the user that may change rapidly.

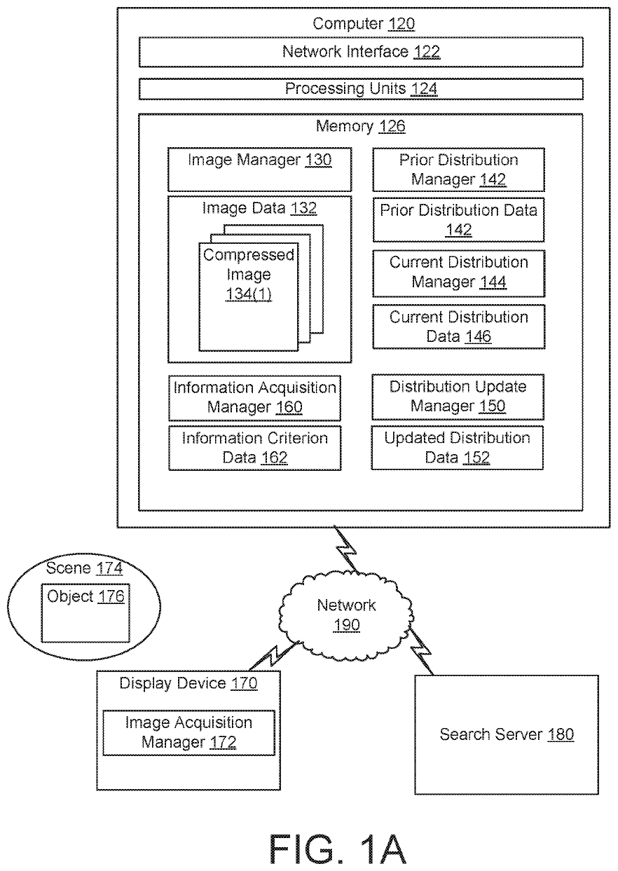

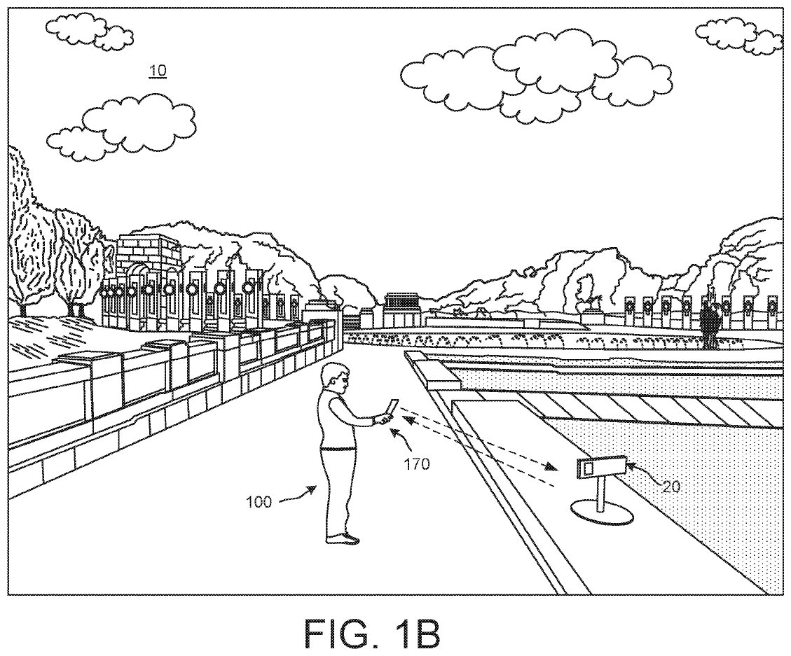

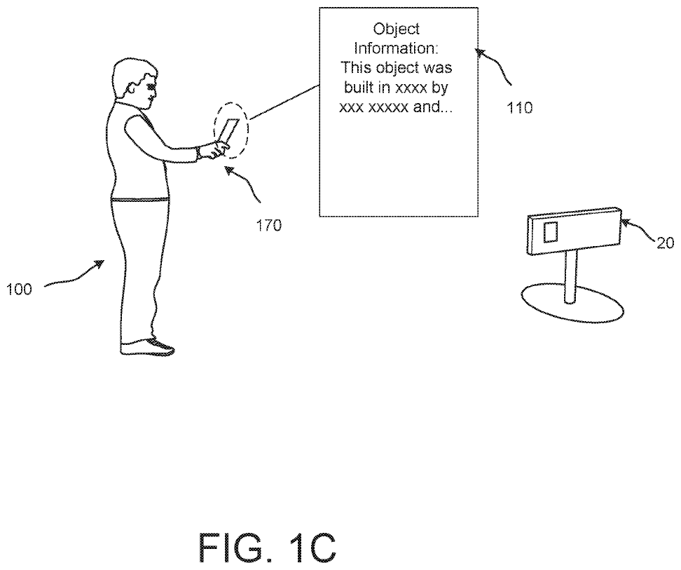

FIG. 1A is a diagram that illustrates an example electronic environment 100 in which the above-described technical solution may be implemented. The computer 120 is configured to perform visual search on images provided by a display device 170.

FIG. 1B is a diagram that illustrates an example scene 10 including an object 20 and a user 100 with a device 170 configured to capture an image of the object. Here, the user 100 directs (e.g., points) a camera on the device 170 toward the object 20 in order to obtain a digital supplement, e.g., information from a network such as the World Wide Web, about the object 20. In some implementations, the user 100 points the camera on the device 170 at the object 20 until such a digital supplement is received at the device 170.

In some implementations, the device 170 compresses each image, e.g., using an encoder for a lossy compression scheme, before sending the image to a computer over the network that obtains a digital supplement for the object 20. In such implementations, the images may be vastly different from each other because in a lossy compression scheme, some data included in the image may be lost. The data that is lost in one image may be different than the data lost in another image because such compressions may vary widely based on very small differences between the images. So, a first image captured by the device 170 at a first time is different from a second image captured by the device 170 at a second time because the lossy compression of the first image is different from the lossy compression of the second image. For example, the user 100 is likely not perfectly still and small movements may result in differences in camera position and orientation and accordingly small differences in the images.

FIG. 1C is a diagram that illustrates an example digital supplement 110 retrieved (e.g., received) by the device 170 associated with the object 20 in the scene 10. In some implementations, the digital supplement 110 takes the form of a web page providing information about the object 20. In some implementations, the digital supplement 110 takes the form of static text, audio, video, interactive content, and the like.

Returning to FIG. 1A, the computer 120 includes a network interface 122, one or more processing units 124, and memory 126. The network interface 122 includes, for example, Ethernet adaptors, Token Ring adaptors, and the like, for converting electronic and/or optical signals received from the network 150 to electronic form for use by the computer 120. The set of processing units 124 include one or more processing chips and/or assemblies. The memory 126 includes both volatile memory (e.g., RAM) and non-volatile memory, such as one or more ROMs, disk drives, solid state drives, and the like. The set of processing units 124 and the memory 126 together form control circuitry, which is configured and arranged to carry out various methods and functions as described herein.

In some implementations, one or more of the components of the computer 120 can be, or can include processors (e.g., processing units 124) configured to process instructions stored in the memory 126. Examples of such instructions as depicted in FIG. 1 include an entity manager 130, a prediction manager 140, a recrawl manager 150, and recrawl policy manager 160. Further, as illustrated in FIG. 1A, the memory 126 is configured to store various data, which is described with respect to the respective managers that use such data. Note that, in some implementations, an entity page corresponds to an offer page that includes an offer to sell a product.

The image manager 130 is configured to receive image data 132. In some implementations, the image manager 130 receives the image data 132 over the network interface 122, i.e., over a network (such as network 190) from the display device 170. In some implementations, the image manager 130 receives the image data 132 from local storage (e.g., a disk drive, flash drive, SSD, or the like).

The image data 132 represents an image of a scene as viewed through the display device 170 via, e.g., an image acquisition manager 172 configured to obtain the image through the camera and send the image data 132 to the computer 120. In some implementations, the image data takes the form of a sequence of frames of compressed image data 134(1), 134(2), . . . , 134(N).

The compressed images 134(1), . . . , 134(N) represent an encoded form of the image data as generated by the image acquisition manager 172. The display device 170 is configured to perform an encoding operation on the generated image data prior to transmitting the image data to the computer 120. In some implementations, the type of encoding used (e.g., JPEG) for compression is important only to the effect that any classifier configured to determine whether the image contains an object belonging to an object class is trained using images similarly compressed. In this way, there need not be any decoding operations carried out for classification. Moreover, successive image frames, e.g., compressed image 134(2) are not likely the same as previous frames, e.g., compressed image 134(1) because small changes in camera orientation or position may cause large alterations in a compressed image. In some implementations, however, there may be a decoding step before any classification occurs.

In some implementations, the image acquisition manager 172 is also configured to identify a textual description of an object in a scene. For example, the image acquisition manager 172 associate certain image data with a text descriptor such as a name of a person, a place, a product, an artwork, or the like. The image acquisition manager 172 may then include such a textual description with the image data 132 so that identification of possible objects for classification is simplified.

The prior distribution manager 140 is configured to obtain prior distribution data 142 representing a prior probability distribution. In some implementations, the prior distribution data 142 is generated by the prior distribution manager 142 based on training data from an object classifier. In some implementations, the object classifier includes a convolutional neural network (CNN) and the training data includes prior visual search results.

The prior distribution data 142 represents a prior probability distribution indicating a likelihood that that an object included in an image frame, e.g., 134(1) belongs to an object class. In some implementations, the prior distribution data 142 includes a distribution identifier (e.g., “beta,” “gamma,” “binomial,” and so on) and values of parameters associated with the distribution identifier. In some implementations, the prior distribution data includes probability density values that, in aggregate, form a probability distribution. In some implementations, the prior probability distribution is distributed over possible probability values between 0 and 1. That is, the coarse classification indicates whether the object belongs to a coarsely-defined object class, with further layers of object classes forming a tree structure. The various paths along the tree structure provide the distribution of probabilities for the coarsely-defined object class.

In some implementations, a determination of whether an image containing an object belonging to a coarse class belongs to a more refined class is performed using a set of heuristics derived from empirical statistical data. For example, an object determined to be a dog may be a poodle or a hound. Determining whether the dog is a poodle or hound involves determining whether there is a higher likelihood of any dog being a poodle or hound. In some implementations, there is a whitelist or blacklist indicating whether such a refined class should be considered in the visual search.

The current distribution manager 144 is configured to indicate whether image data 132, e.g., the compressed image 132(1) includes an object belonging to an object class. The current distribution manager 144 is configured to generate current distribution data 146 based on whether the object belongs to an object class.

The current distribution data 146 represents a likelihood that the image data 132, specifically the compressed image 134(1), contains an object belonging to an object class. In some implementations, the current distribution data 146 is a binomial distribution based on parameters indicating whether the object in the image belongs to the object class. That is, the parameters of the binomial distribution are, in some arrangements, a number of times that a succession of image frames has an object belonging to an object class and a number of times that the succession of image frames does not have an object belonging to the object class.

The distribution update manager 150 is configured to update the prior probability distribution based on the previous prior probability distribution 142 and the current probability distribution 146 to produce updated distribution data 152. In some implementations, the distribution update manager 150 is configured to multiply the previous prior distribution 142 by the current probability distribution 146. In such implementations, the distribution update manager 150 is configured to normalize the product by dividing the product by a sum of the product over all probabilities. In some implementations, when the previous prior distribution 142 is a beta distribution and the current distribution 146 is a binomial distribution (and the conjugate to the prior), then the distribution update manager 150 is configured to add respective values of parameters associated with the current distribution 146 to parameters associated with the prior distribution 142. In this case, the updated prior distribution 152 is a beta distribution with updated parameter values.

The updated distribution data 152 represents a new prior distribution resulting from the updating performed by the distribution update manager 150. If the previous prior distribution 142 is a beta distribution and the current distribution 146 is a binomial distribution, then the updated prior distribution 152 is a beta distribution. Moreover, in this case, if an image frame includes an object that belongs to an object class, then a first parameter of the beta distribution is incremented, and a second parameter is unchanged. In contrast, if the image frame does not include the object that belongs to the object class, then the first parameter of the beta distribution is unchanged, and the second parameter is incremented.

The information acquisition manager 160 is configured to determine whether the updated prior probability distribution 152 satisfies a criterion represented by information criterion data 162. In some implementations, the information acquisition manager 160 is configured to derive a probability measure from the updated prior probability distribution 152. For example, when the criterion states that a probability measure is greater than a threshold, the information acquisition manager 160 is configured to compare the derived probability measure to the threshold. In some implementations, the probability measure is a mean of the probability distribution. In some implementations, the probability measure is a mean of the probability distribution.

The information acquisition manager 160 is also configured to obtain information from the search server 180 regarding the object based on information criterion data 162. For example, if the object is determined to be a menu from a particular restaurant, then the information may take the form of a review of that restaurant. The review may be taken from indexed search results produced by the search server. Further, the information acquisition manager 160 sends this information to the display device 170 in response to criteria specified in the information criterion data 162 being satisfied.

The information criterion data 162 represents the criterion or criteria used to determine whether to send retrieved information to the display device 170. In some implementations, a criterion is that the mean of the prior probability distribution is greater than a threshold. In this case, the information criterion data 162 may take the form of the threshold value.

The components (e.g., modules, processing units 124) of the user device 120 can be configured to operate based on one or more platforms (e.g., one or more similar or different platforms) that can include one or more types of hardware, software, firmware, operating systems, runtime libraries, and/or so forth. In some implementations, the components of the computer 120 can be configured to operate within a cluster of devices (e.g., a server farm). In such an implementation, the functionality and processing of the components of the computer 120 can be distributed to several devices of the cluster of devices.

The components of the computer 120 can be, or can include, any type of hardware and/or software configured to process attributes. In some implementations, one or more portions of the components shown in the components of the computer 120 in FIG. 1 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the computer 120 can be, or can include, a software module configured for execution by at least one processor (not shown). In some implementations, the functionality of the components can be included in different modules and/or different components than those shown in FIG. 1, including combining functionality illustrated as two components into a single component.

Although not shown, in some implementations, the components of the computer 120 (or portions thereof) can be configured to operate within, for example, a data center (e.g., a cloud computing environment), a computer system, one or more server/host devices, and/or so forth. In some implementations, the components of the computer 120 (or portions thereof) can be configured to operate within a network. Thus, the components of the computer 120 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the computer 120 can be, or can include, processors configured to process instructions stored in a memory. For example, an image manager 130 (and/or a portion thereof), a prior distribution manager 140 (and/or a portion thereof), a current distribution manager 144 (and/or a portion thereof), a distribution update manager 150 (and/or a portion thereof), and an information acquisition manager 160 (and/or a portion thereof) can be a combination of a processor and a memory configured to execute instructions related to a process to implement one or more functions.

In some implementations, the memory 126 can be any type of memory such as a random-access memory, a disk drive memory, flash memory, and/or so forth. In some implementations, the memory 126 can be implemented as more than one memory component (e.g., more than one RAM component or disk drive memory) associated with the components of the VR server computer 120. In some implementations, the memory 126 can be a database memory. In some implementations, the memory 126 can be, or can include, a non-local memory. For example, the memory 126 can be, or can include, a memory shared by multiple devices (not shown). In some implementations, the memory 126 can be associated with a server device (not shown) within a network and configured to serve the components of the computer 120. As illustrated in FIG. 1, the memory 126 is configured to store various data, including image data 132, prior distribution data 142, current distribution data 146, updated distribution data 152, and information criterion data 162.

The beta distribution is defined as follows:

$$P ( q ) = \frac{{{q}^{α - 1} ( 1 - q )}^{β - 1}}{B ( α , β )} , \\ B ( α , β ) = \frac{Γ ( α ) Γ ( β )}{Γ ( α + β )} .$$

where α and β are hyperparameters of the beta distribution and q is a probability. That is, B (α, β) is the beta function and Γ(α) is the gamma function. In some implementations, the prior probability distribution 142 and the posterior probability distribution 152 take this mathematical form. The prior distribution 142 is hence a conjugate prior for a likelihood function that, in some implementations, takes the form of a binomial distribution. One such binomial distribution takes the following form:

$$P ( s , f \vert q ) = ( \begin{matrix}s + f \\ s\end{matrix} ) {{q}^{s} ( 1 - q )}^{f} .$$

The posterior probability is given by Bayes' Theorem:

$$P ( q \vert s , f ) = \frac{P ( s , f \vert q ) P ( q )}{{\int }_{0}^{1} P ( s , f \vert y ) P ( y ) dy} .$$

When the prior is a beta distribution, computation of the posterior probability is reduced to a Bayesian updating of the prior as follows:

$$P ( q \vert s , f ) = \frac{{{q}^{α + s - 1} ( 1 - q )}^{β + f - 1}}{B ( α + s , β + f )} .$$

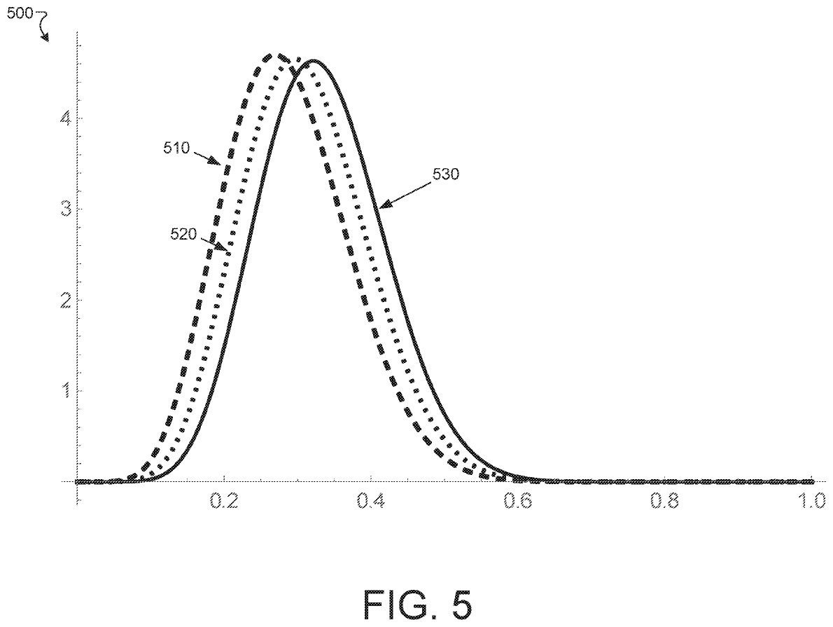

That is, the updating of the prior probability distribution involves adding respective values of the parameters of the respective distributions. Examples of these distributions are discussed in further detail with respect to FIG. 5.

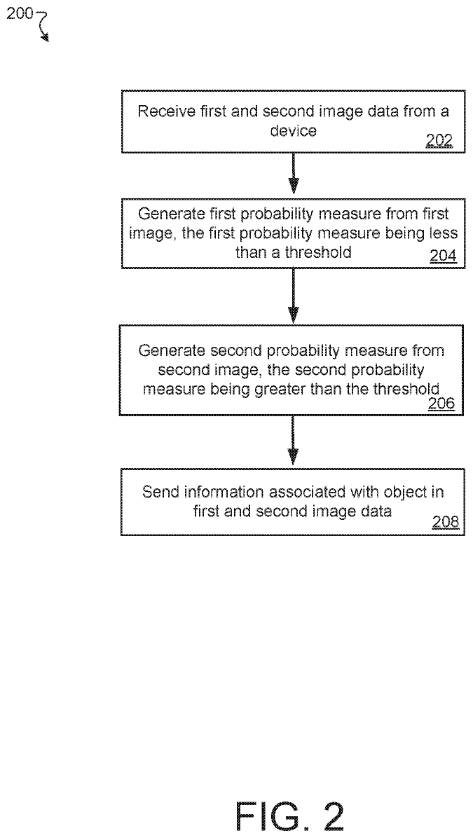

FIG. 2 is a flow chart depicting an example method 200 of performing a visual search according to the above-described improved techniques. The method 200 may be performed by software constructs described in connection with FIG. 1, which reside in memory 126 of the computer 120 and are run by the set of processing units 124.

At 202, the image manager 130 receives first and second image data (e.g., compressed images 134(1,2)) from a device (e.g., display device 170), the first image data representing a first image of a scene, the first image of the scene including an object. For example, the scene may include a building displaying a menu, and the object can be the menu.

At 204, the information acquisition manager 160 generates a first probability measure based on the first image data, the first probability measure indicating a likelihood that the object included in the first image of the scene belongs to an object class, the first probability measure not satisfying a specified criterion (in information criterion data 162). In some implementations, the first probability measure is a mean of a prior probability distribution obtained by the prior distribution manager 140 represented by prior distribution data 142.

At 206, in response to the first probability measure not satisfying the specified criterion, the distribution update manager 150 updates the first probability measure based on the second image data (e.g., 134(2)) to produce a second probability measure, the second probability measure satisfying the specified criterion. Again, when the first probability measure of based on a beta distribution, the current distribution manager 144 generates a binomial distribution that is based on whether a classifier determines that the object included in the second image of the scene belongs to the object class. In some implementations, the second probability measure is a mean of the updated prior probability distribution, i.e., the updated prior probability.

At 208, in response to the second probability measure satisfying the specified criterion, the information acquisition manager 160 sends information, e.g., a digital supplement, associated with the object to the device. In some implementations, the information takes the form of web content concerning the object. For example, if the object is a menu from a restaurant, the information may take the form of a review of the restaurant taken from a restaurant review website.

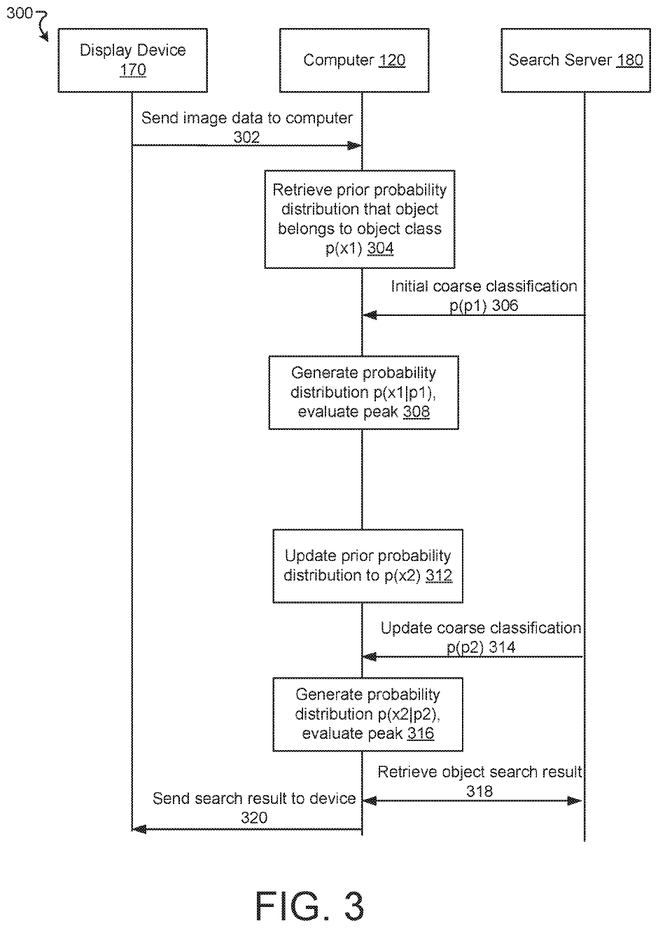

FIG. 3 is a sequence diagram of an example visual search 300 involving the display device 170, the computer 120, and the search server 180. The visual search 300 may be performed by software constructs described in connection with FIG. 1, which reside in memory 126 of the computer 120 and are run by the set of processing units 124.

At 302, the display device 170 sends image data to the computer 120 as described above with regard to FIGS. 1 and 2.

At 304, the computer 120 retrieves a prior probability distribution p(q) indicating that an object in the image data belongs to an object class.

At 306, the computer 120 receives an initial coarse classification result which takes the form of a likelihood function (or current distribution) p(s, f|q). In some implementations, data representing the likelihood function is stored locally on the computer 120.

At 308, the computer 120 generates a posterior probability distribution p(q|s, f) and evaluates its mean against a specified threshold. In this case, the mean is less than the threshold.

At 312, the computer 120 replaces the previous prior distribution with the posterior distribution. That is, p(q)←p(q|s, f).

At 314, the computer 120 receives a new coarse classification result based on the new image data which takes the form of a likelihood function (or current distribution) p(s, f|q).

At 316, the computer 120 generates a posterior probability distribution p(q|s, f) and evaluates its mean against a specified threshold. In this case, the mean is greater than the threshold.

At 318, the computer 120 retrieves a search result, e.g., a digital supplement, for the object from the search server 180.

At 320, the computer 120 sends the search result to the display device 170.

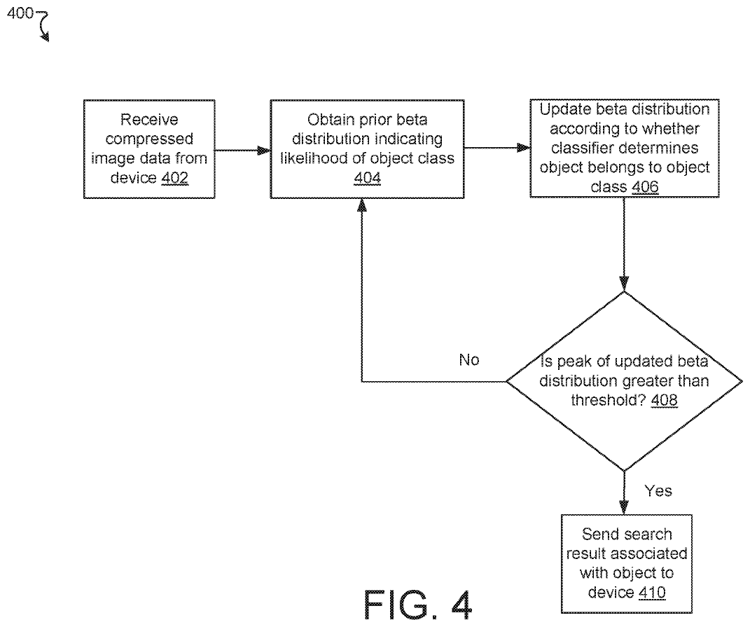

FIG. 4 is a flow chart illustrating an example visual search decision process 400. The visual search decision process 400 may be performed by software constructs described in connection with FIG. 1, which reside in memory 126 of the computer 120 and are run by the set of processing units 124.

At 402, the computer 120 receives compressed image data from the display device 170.

At 404, the computer 120 obtains a prior distribution, which takes the form of a beta distribution as defined above. The prior distribution indicates a likelihood of the object class.

At 406, the computer 120 updates the beta distribution according to whether a classifier determines that an object belonging to an object class is represented in the image data. For example, if the image data does not contain such an object, then the computer 120 increments the value of β; otherwise, the computer 120 increments the value of α.

At 408, the computer 120 determines whether the mean of the updated prior distribution is greater than a specified threshold. If the mean is greater than the threshold, then the process 400 advances to 410. If not, then the process 400 returns to 404.

At 410, the computer 120 obtains and sends a search result associated with the object.

FIG. 5 is a diagram illustrating a plot of successive prior probability distributions 500. For example the curve 510 represents a beta distribution with α=8 and β=20. This produces a mean at

$$\frac{α - 1}{α + β - 2} = \frac{7}{26} \approx 0.27 .$$

If the specified threshold is 0.33 then the beta distribution would need to be updated. Suppose that the computer 120 sends new image data; the computer 120 will update the distribution according to whether an object belonging to an object class is determined to be in the new image data. If that is the case, then the computer 120 increments α. The new curve 520 has a mean at

$$\frac{α - 1}{α + β - 2} = \frac{8}{26} \approx 0.31 .$$

In this case, the mean is still less than the threshold; accordingly, the process 400 (FIG. 4) repeats itself and the computer 120 sends another new image data. In response, the computer 120 determines whether the object belonging to the object class is determined to be in this other, new image data. If so, then the computer 120 increments α again, and the mean of the curve 530 is at

$$\frac{α - 1}{α + β - 2} = \frac{9}{26} \approx 0.35 ,$$

which exceeds me threshold and the computer 120 can send a search result to the display device 170.

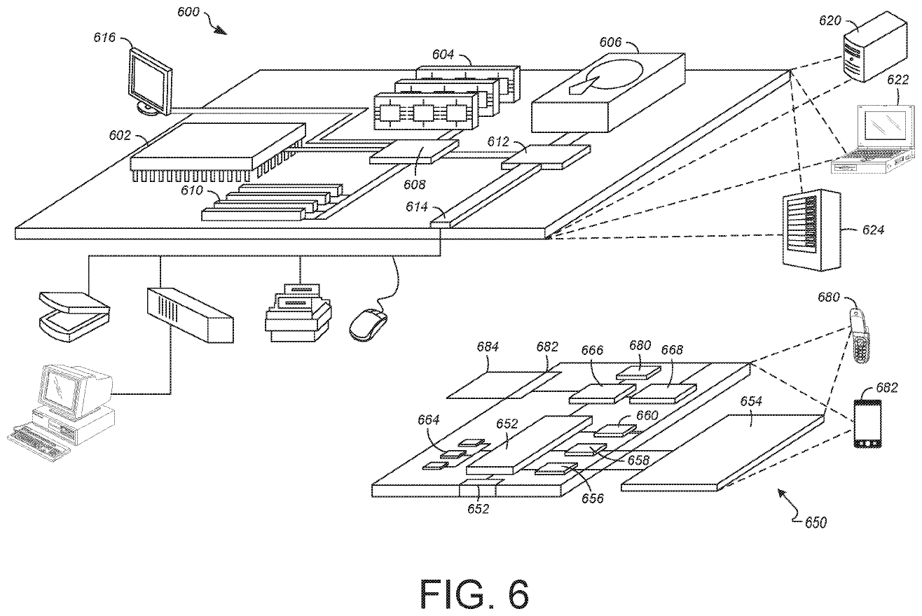

FIG. 6 illustrates an example of a generic computer device 600 and a generic mobile computer device 650, which may be used with the techniques described here. Computer device 600 is one example configuration of computer 120 of FIG. 1 and FIG. 2.

As shown in FIG. 6, computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high-speed controller 608 manages bandwidth-intensive operations for the computing device 500, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 506 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite exemplary relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

In the following some examples are described.

### Example 1: A Method, Comprising:

receiving, during a visual search operation for an object in a scene, first image data and second image data from a device, the first image data representing a first image of the scene at a first time and second image data representing a second image of the scene at a second time;
generating a first visual match probability based on the first image data, the first visual match probability indicating a likelihood that the object included in the first image of the scene in the first image of the scene belongs to a coarse object class;
in response to determining that the first visual match probability not satisfying a criterion, updating the first visual match probability based on the second image data to produce a second visual match probability; and after determining that the second visual match probability satisfies the criterion, sending a digital supplement associated with the object to the device as part of the visual search operation.
Example 2: The method as in example 1, wherein the criterion includes a visual search probability being greater than or equal to a threshold.
Example 3: The method as in claim 2, wherein the first visual search probability is a mean of a first probability distribution over probabilities of the object in the first image belongs to the object class, the first probability distribution having the mean as the first probability measure including a first set of parameter values, and wherein the second visual search probability is a mean of a second probability distribution, the second probability distribution having the mean as the second visual search probability including a second set of parameter values.
Example 4: The method as in example 3, wherein, after receiving the second image data, the first probability distribution is a prior distribution, and wherein updating the first probability measure includes:
multiplying the prior distribution by a current probability distribution, the current probability distribution representing a distribution of probabilities that the parameters of the current probability distribution have particular values given a probability that the object included in the second image of the scene represented by the second image data belongs to the object class.
Example 5: The method as in example 4, wherein the current probability distribution is a binomial distribution.
Example 6: The method as in example 3, wherein, after receiving the second image data, the first probability distribution is a prior distribution, the prior distribution being based on a values of a first parameter and a second parameter, wherein the method further comprises:
generating a current probability distribution, the current probability distribution representing a distribution of probabilities that the parameters of the current probability distribution have particular values given a probability that the object included in the second image of the scene represented by the second image data belongs to the object class, the current probability distribution being based on values of a third parameter and a fourth parameter, and
wherein updating the first visual match probability includes:
adding the values of the first parameter and the third parameter and adding the values of the second parameter and the fourth parameter.
Example 7: The method as in example 3, wherein, after receiving the second image data, the first probability distribution is a prior distribution, the prior distribution being based on a values of a first parameter and a second parameter, and wherein updating the first visual search probability includes:
in response to the object being determined as being included in the object class, incrementing the value of the first parameter and not incrementing the value of the second parameter; and
in response to the object being determined as being included in the object class, incrementing the value of the second parameter and not incrementing the value of the first parameter.
Example 8: The method as in example 3, wherein the first probability distribution and the second probability distribution are beta distributions.
Example 9: The method of at least one of the preceding examples, wherein the digital supplement comprises data about the object not contained in the image date, the digital supplement comprising data from the world wide web and/or a database.
Example 10: A computer program product comprising a nontransitory storage medium, the computer program product including code that, when executed by processing circuitry of a computer, causes the processing circuitry to perform a method, the method comprising:
receiving, during a visual search operation for an object in a scene, first image data and second image data from a device, the first image data representing a first image of the scene at a first time and second image data representing a second image of the scene at a second time;
generating a first visual match probability based on the first image data, the first visual match probability indicating a likelihood that the object included in the first image of the scene in the first image of the scene belongs to a coarse object class; in response to determining that the first visual match probability not satisfying a first criterion, updating the first visual match probability based on the second image data to produce a second visual match probability;
after determining that the second visual match probability satisfies the first criterion, determining a likelihood that the object belongs to a fine object class; and in response to determining that the likelihood of the object belonging to the fine object class satisfies a second criterion, sending a digital supplement associated with the object to the device as part of the visual search operation.
Example 11: The computer program product as in example 10, wherein the first criterion includes the probability measure being greater than or equal to a threshold.
Example 12: The computer program product as in example 11, wherein the first probability measure is a mean of a first probability distribution over probabilities of the object belonging to the coarse object class, the first probability distribution having the mean as the first probability measure including a first set of parameter values, and wherein the second probability measure is a mean of a second probability distribution, the second probability distribution having the mean as the second probability measure including a second set of parameter values.
Example 13: The computer program product as in example 12, wherein, after receiving the second image data, the first probability distribution is a prior distribution, and
wherein updating the first probability measure includes:
multiplying the prior distribution by a current probability distribution, the current probability distribution representing a distribution of probabilities that the parameters of the current probability distribution have particular values given a probability that the object included in the second image of the scene represented by the second image data belongs to the coarse object class.
Example 14: The computer program product as in example 13, wherein the current probability distribution is a binomial distribution.
Example 15: The computer program product as in example 12, wherein, after receiving the second image data, the first probability distribution is a prior distribution, the prior distribution being based on a values of a first parameter and a second parameter,
wherein the method further comprises:
generating a current probability distribution, the current probability distribution representing a distribution of probabilities that the parameters of the current probability distribution have particular values given a probability that the object included in the second image of the scene represented by the second image data belongs to the coarse object class, the current probability distribution being based on values of a third parameter and a fourth parameter, and
wherein updating the first probability measure includes:
adding the values of the first parameter and the third parameter and adding the values of the second parameter and the fourth parameter.
Example 16: The computer program product as in example 12, wherein, after receiving the second image data, the first probability distribution is a prior distribution, the prior distribution being based on a values of a first parameter and a second parameter, and
wherein updating the first probability measure includes:
in response to the object included in the second scene being classified as belonging to the coarse object class, incrementing the value of the first parameter and not incrementing the value of the second parameter; and in response to the object included in the second scene being classified as not belonging to the coarse object class, incrementing the value of the second parameter and not incrementing the value of the first parameter.
Example 17: The computer program product as in example 12, wherein the first probability distribution and the second probability distribution are beta distributions.
Example 18: The computer program product of at least one of the 10 to 17, wherein the digital supplement comprises data about the object not contained in the image date, the digital supplement comprising data from the world wide web and/or a database.
Example 19: An electronic apparatus, the electronic apparatus comprising: memory; and
processing circuitry coupled to the memory, the processing circuitry being configured to:
receive, during a visual search operation for an object in a scene, first image data and second image data from a device, the first image data representing a first image of the scene at a first time and second image data representing a second image of the scene at a second time;
generate a first visual match probability based on the first image data, the first visual match probability indicating a likelihood that the object included in the first image of the scene in the first image of the scene belongs to a coarse object class; in response to determining that the first visual match probability not satisfying a criterion, update the first visual match probability based on the second image data to produce a second visual match probability; and
after determining that the second visual match probability satisfies the criterion, send a digital supplement associated with the object to the device as part of the visual search operation.
Example 20: The electronic apparatus as in example 19, wherein the first visual search probability is a mean of a first probability distribution over probabilities of the object in the first image belongs to the object class, the first probability distribution having the mean as the first probability measure including a first set of parameter values, and
wherein the second visual search probability is a mean of a second probability distribution, the second probability distribution having the mean as the second visual search probability including a second set of parameter values.
Example 21: The electronic apparatus as in example 20, wherein, after receiving the second image data, the first probability distribution is a prior distribution, the prior distribution being based on a values of a first parameter and a second parameter, wherein the processing circuitry is further configured to:
a current probability distribution, the current probability distribution representing a distribution of probabilities that the parameters of the current probability distribution have particular values given a probability that the object included in the second image of the scene represented by the second image data belongs to the object class, the current probability distribution being based on values of a third parameter and a fourth parameter, and wherein the processing circuitry configured to update the first visual match probability is further configured to:
add the values of the first parameter and the third parameter and adding the values of the second parameter and the fourth parameter.
Example 22: The electronic apparatus as in example 20, wherein, after receiving the second image data, the first probability distribution is a prior distribution, the prior distribution being based on a values of a first parameter and a second parameter, and wherein the processing circuitry configured to update the first visual match probability is further configured to:
in response to the object included in the second scene being classified as belonging to the object class, increment the value of the first parameter and not incrementing the value of the second parameter; and
in response to the object included in the second scene being classified as not belonging to the object class, increment the value of the second parameter and not incrementing the value of the first parameter.

1. A method, comprising:
receiving, during a visual search operation for an object in a scene, first image data and second image data from a device, the first image data representing a first image of the scene at a first time and second image data representing a second image of the scene at a second time;
generating a first visual match probability based on the first image data, the first visual match probability indicating a likelihood that the object included in the first image of the scene in the first image of the scene belongs to a coarse object class;
in response to determining that the first visual match probability not satisfying a criterion, updating the first visual match probability based on the second image data to produce a second visual match probability; and
after determining that the second visual match probability satisfies the criterion, sending a digital supplement associated with the object to the device as part of the visual search operation.

2. The method as in claim 1, wherein the criterion includes a visual search probability being greater than or equal to a threshold.

3. The method as in claim 2, wherein the first visual search probability is a mean of a first probability distribution over probabilities of the object in the first image belongs to the object class, the first probability distribution having the mean as the first probability measure including a first set of parameter values, and
wherein the second visual search probability is a mean of a second probability distribution, the second probability distribution having the mean as the second visual search probability including a second set of parameter values.

4. The method as in claim 3, wherein, after receiving the second image data, the first probability distribution is a prior distribution, and
wherein updating the first probability measure includes:
multiplying the prior distribution by a current probability distribution, the current probability distribution representing a distribution of probabilities that the parameters of the current probability distribution have particular values given a probability that the object included in the second image of the scene represented by the second image data belongs to the object class.

5. The method as in claim 4, wherein the current probability distribution is a binomial distribution.

6. The method as in claim 3, wherein, after receiving the second image data, the first probability distribution is a prior distribution, the prior distribution being based on a values of a first parameter and a second parameter,
wherein the method further comprises:
generating a current probability distribution, the current probability distribution representing a distribution of probabilities that the parameters of the current probability distribution have particular values given a probability that the object included in the second image of the scene represented by the second image data belongs to the object class, the current probability distribution being based on values of a third parameter and a fourth parameter, and
wherein updating the first visual match probability includes:
adding the values of the first parameter and the third parameter and adding the values of the second parameter and the fourth parameter.

7. The method as in claim 3, wherein, after receiving the second image data, the first probability distribution is a prior distribution, the prior distribution being based on a values of a first parameter and a second parameter, and
wherein updating the first visual search probability includes:
in response to the object being determined as being included in the object class, incrementing the value of the first parameter and not incrementing the value of the second parameter; and
in response to the object being determined as being included in the object class, incrementing the value of the second parameter and not incrementing the value of the first parameter.

8. The method as in claim 3, wherein the first probability distribution and the second probability distribution are beta distributions.

9. The method of claim 1, wherein the digital supplement comprises data about the object not contained in the image data, the digital supplement comprising data from the world wide web and/or a database.

10. A computer program product comprising a nontransitory storage medium, the computer program product including code that, when executed by processing circuitry of a computer, causes the processing circuitry to perform a method, the method comprising:
receiving, during a visual search operation for an object in a scene, first image data and second image data from a device, the first image data representing a first image of the scene at a first time and second image data representing a second image of the scene at a second time;
generating a first visual match probability based on the first image data, the first visual match probability indicating a likelihood that the object included in the first image of the scene in the first image of the scene belongs to a coarse object class;
in response to determining that the first visual match probability not satisfying a first criterion, updating the first visual match probability based on the second image data to produce a second visual match probability;
after determining that the second visual match probability satisfies the first criterion, determining a likelihood that the object belongs to a fine object class; and
in response to determining that the likelihood of the object belonging to the fine object class satisfies a second criterion, sending a digital supplement associated with the object to the device as part of the visual search operation.

11. The computer program product as in claim 10, wherein the first criterion includes the probability measure being greater than or equal to a threshold.

12. The computer program product as in claim 11, wherein the first probability measure is a mean of a first probability distribution over probabilities of the object belonging to the coarse object class, the first probability distribution having the mean as the first probability measure including a first set of parameter values, and
wherein the second probability measure is a mean of a second probability distribution, the second probability distribution having the mean as the second probability measure including a second set of parameter values.

13. The computer program product as in claim 12, wherein, after receiving the second image data, the first probability distribution is a prior distribution, and
wherein updating the first probability measure includes:
multiplying the prior distribution by a current probability distribution, the current probability distribution representing a distribution of probabilities that the parameters of the current probability distribution have particular values given a probability that the object included in the second image of the scene represented by the second image data belongs to the coarse object class.

14. The computer program product as in claim 13, wherein the current probability distribution is a binomial distribution.

15. The computer program product as in claim 12, wherein, after receiving the second image data, the first probability distribution is a prior distribution, the prior distribution being based on a values of a first parameter and a second parameter,
wherein the method further comprises:
generating a current probability distribution, the current probability distribution representing a distribution of probabilities that the parameters of the current probability distribution have particular values given a probability that the object included in the second image of the scene represented by the second image data belongs to the coarse object class, the current probability distribution being based on values of a third parameter and a fourth parameter, and
wherein updating the first probability measure includes:
adding the values of the first parameter and the third parameter and adding the values of the second parameter and the fourth parameter.

16. The computer program product as in claim 12, wherein, after receiving the second image data, the first probability distribution is a prior distribution, the prior distribution being based on a values of a first parameter and a second parameter, and
wherein updating the first probability measure includes:
in response to the object included in the second scene being classified as belonging to the coarse object class, incrementing the value of the first parameter and not incrementing the value of the second parameter; and
in response to the object included in the second scene being classified as not belonging to the coarse object class, incrementing the value of the second parameter and not incrementing the value of the first parameter.

17. The computer program product as in claim 12, wherein the first probability distribution and the second probability distribution are beta distributions.

18. The computer program product of claim 1, wherein the digital supplement comprises data about the object not contained in the image date, the digital supplement comprising data from the world wide web and/or a database.

19. An electronic apparatus, the electronic apparatus comprising:
memory; and
processing circuitry coupled to the memory, the processing circuitry being configured to:
receive, during a visual search operation for an object in a scene, first image data and second image data from a device, the first image data representing a first image of the scene at a first time and second image data representing a second image of the scene at a second time;
generate a first visual match probability based on the first image data, the first visual match probability indicating a likelihood that the object included in the first image of the scene in the first image of the scene belongs to a coarse object class;
in response to determining that the first visual match probability not satisfying a criterion, update the first visual match probability based on the second image data to produce a second visual match probability; and
after determining that the second visual match probability satisfies the criterion, send a digital supplement associated with the object to the device as part of the visual search operation.

20. The electronic apparatus as in claim 19, wherein the first visual search probability is a mean of a first probability distribution over probabilities of the object in the first image belongs to the object class, the first probability distribution having the mean as the first probability measure including a first set of parameter values, and
wherein the second visual search probability is a mean of a second probability distribution, the second probability distribution having the mean as the second visual search probability including a second set of parameter values.

21. The electronic apparatus as in claim 20, wherein, after receiving the second image data, the first probability distribution is a prior distribution, the prior distribution being based on a values of a first parameter and a second parameter,
wherein the processing circuitry is further configured to:
a current probability distribution, the current probability distribution representing a distribution of probabilities that the parameters of the current probability distribution have particular values given a probability that the object included in the second image of the scene represented by the second image data belongs to the object class, the current probability distribution being based on values of a third parameter and a fourth parameter, and
wherein the processing circuitry configured to update the first visual match probability is further configured to:
add the values of the first parameter and the third parameter and adding the values of the second parameter and the fourth parameter.

22. The electronic apparatus as in claim 20, wherein, after receiving the second image data, the first probability distribution is a prior distribution, the prior distribution being based on a values of a first parameter and a second parameter, and
wherein the processing circuitry configured to update the first visual match probability is further configured to:
in response to the object included in the second scene being classified as belonging to the object class, increment the value of the first parameter and not incrementing the value of the second parameter; and
in response to the object included in the second scene being classified as not belonging to the object class, increment the value of the second parameter and not incrementing the value of the first parameter.
